(19) United States
(12) Patent Application Publication
(10) Pub. No.: US 2003/0169852 A1
(43) Pub. Date: Sep. 11, 2003

(54) Emergency speakerphone apparatus

(76) Inventor: Armando Otero, Tampa, FL (US)

Correspondence Address: ARMANDO OTERO, 714 W. VIRGINIA AVE., TAMPA, FL, 33603, US

(21) Appl. No.: 10/091,087

(22) Filed: Mar. 6, 2002

(51) Int. Cl. H04M 11/04

(52) U.S. Cl. 379/37

(57) ABSTRACT

An simplified emergency telephonic apparatus for calling an emergency operator having a single emergency button, a speaker, a microphone, voice recognition software electrically integrated, a visual indicator, a volume adjustment means, and security software means electrically integrated into said apparatus thereby allowing access to said apparatus by only authorized personnel from a remote location.

### BACKGROUND

1. Field of the Invention

Generally, this invention is directed towards an emergency-calling device. More specifically, this invention relates to a simplified emergency speakerphone that will call an emergency operator with a single push of a button and allow two-way communication without a handset.

2. Description of the Prior Art

Several emergency phone forwarding systems have been previously discussed as in U.S. Pat. No. 6,285,867,wherein, “A combination personal audio device and emergency phone provides a user with personal audio entertainment while also providing full duplex wireless communication with an emergency response service. The apparatus includes an audio information access device, such as a compact disc player, for accessing audio information and generating an electrical audio information signal based upon the audio information. A transmitter generates an outgoing communication signal that is capable of reaching and being received by the emergency response service. A single emergency response switch is the user's sole means for activating the transmitter. When pressed, the emergency response switch activates the transmitter to generate the outgoing communication signal. A receiver receives an incoming communication signal from the emergency response service, and generates an audio communication signal based upon the incoming communication signal. An audio amplifier receives and amplifies the electrical audio information signal and the audio communication signal to produce amplified electrical audio information and an amplified audio communication signal. A sound production device converts the amplified electrical audio information signal and the amplified audio communication signal into acoustical sound waves capable of being aurally perceived by the user. The apparatus includes an aural alarm, such as a siren, and a visual alarm, such as a flashing light, to alert individuals in an area surrounding the apparatus when an emergency situation exists.”

In U.S. Pat. No. 6,115,597, “The present invention teaches an economical disposable emergency cellular phone. A further object of the invention is a new technique for having a large number of cellular phones share the same small group of access numbers and serial numbers in order to reduce the monthly charges to zero for the end consumer.”

In U.S. Pat. No. 6,226,510, “A hand-held wireless communication apparatus transmits and receives cellular radio signals that are compatible with a cellular network, and summons assistance during an emergency situation from multiple emergency response services. The apparatus comprises a lightweight and rigid housing with a cellular transmitter disposed therein. When activated, the cellular transmitter generates first outgoing cellular radio signals, such as paging messages, that contain information for a private emergency response service, and second outgoing cellular radio signals to communicate with a public emergency response service. The apparatus includes an emergency response button which is the sole means of activating the transmitter. When pressed, the emergency response button alone activates the transmitter to cause the transmitter to generate the first and second outgoing cellular radio signals. The apparatus also includes receiver means for receiving incoming cellular radio signals over the cellular network from at least one of the emergency response services, and for converting the incoming cellular radio signals into audio signals. An audio output device receives the audio signals from the receiver means and generates audible messages based on the audio signals. An audible alarm audibly alerts, and a visual alarm visually alerts individuals in the area surrounding the apparatus that an emergency situation exists.”

In U.S. Pat. No. 5,710,803, “A system is provided for automatically dialing and sending out a pre-recorded message in emergency situations to Police, Fire, or Ambulance departments at the push of a single button. The system has separated lighted buttons each for Police, Fire, or Ambulance, with an individual message for each emergency situation. The buttons are color coded and the international symbols for Fire, Police, and Ambulance are embossed on them respectively. The system is capable of storing phone numbers for each emergency service, and has the ability to record and play back a personalized message designed to describe the services needed and the location at which the service is need.”

In U.S. Pat. No. 5,977,747, “A cellular phone battery charger includes a housing, a control circuit assembly mounted within the housing, the control circuit assembly having a power jack for obtaining power supply from a car battery by a cable or a city power supply outlet by a transformer, a coupling element mounted in the housing at the rear side to hold any of a variety of cellular phone connectors for connection to a particular cellular phone, and a batter holder mounted in the housing at the front side and electrically connected to the control circuit assembly for receiving a 9V alkaline battery for providing battery power supply to the connected cellular phone in an emergency case.”

In U.S. Pat. No. 4,993,058, “An illuminated house light display system and a telephone operated emergency indicator device for activating the display. The circuit responds to the dialing of the numeric emergency sequence “9-1-1” and the test sequence “#-9-1-1” and activates the display to provide a visual warning signal to guide summoned emergency personnel. Reset may be accomplished anytime by lifting the handset and dialing a “#”. The generally cubical address display is externally mounted in a clearly visible place. The illuminated display comprises a resilient housing preferably fitted with a translucent, marked screen bearing the appropriate indicia. A bright strobe warning light is housed within the address box. The electronic circuit is mounted within a control box, and it is interconnected with the telephone line via a conventional jack. The circuit comprises a decoder which senses the dialing of digits, and an Initiation circuit interconnected with the decoder. The initiaition circuit comprises a counter, a recognition circuit, and a gate logic circuit for actuating an incrementer when the target dialing sequence occurs. The initiation circuit recognizes the symbol #, which may be dialed at the beginning of a test string of numbers to test telephone equipment. Thus the test sequence #-9-1-1 may be dialed to test the apparatus, without completing an emergency call. A disabling circuit enables a user to hang up the phone after summoning help and make a subsequent call, without stopping the alarm state.”

While some of the prior art may contain some similarities relating to the present invention, none of them teach, suggest or include all of the advantages and unique features of an emergency phone for forwarding calls and allowing emergency personal the ability to gain audio access without the victim picking up the phone.

### SUMMARY

The present invention is directed towards an emergency forwarding speakerphone having a single button to push to get to an emergency operator. The device enables a person to call an emergency number by simply touching a single button. This invention also allows for a person in need to be contacted via speakerphone by an emergency operator without the person in emergency distress initiating the call. The invention also allows for a parental or legal guardian to enter a private security code and gain listening access over the speakerphone to check the status of the person living there.

Accordingly, it is an object of this invention to provide a simplified emergency forwarding speakerphone that can dial a number with a single touch.

Another object of this invention to provide a means of allowing an emergency operator or person of legal guardian to gain audio access of audio in close proximity to the emergency speaker phone without the person picking up the phone.

Another object of this invention is to provide a volume button to allow volume adjustment of the speakerphone.

Still another object of this invention is to provide a visual indicator that will give the status of the unit.

Still yet another object of this invention is to provide speech recognition software that will allow remote activation of the speakerphone without touching the emergency button.

Other objects and a fuller understanding of the invention will become apparent from reading the following detailed description of a preferred embodiment in conjunction with the accompanying drawings.

### BRIEF DESCRIPTION OF THE DRAWINGS

This invention, together with other objects, features, aspects and advantages thereof, will be more clearly understood from the following description, considered in conjunction with the accompanying drawings.

Two sheets of drawings are furnished, sheet one contains FIG. 1 and sheet two contains FIG. 2.

FIG. 1 is a perspective view of the emergency phone connected via phone line to a phone wall phone jack.

FIG. 2 shows a block flow diagram of the primary components used when the remote audio activation is used by an emergency operator or legal guardian.

### LIST OF ELEMENTS

1. Emergency speaker phone

2. Emergency button

3. Visual indicator

4. Speaker

5. Phone line

6. Microphone

7. Wall phone jack

8. Emergency operator

9. Legal guardian

10. Speaker phone audio output

11. Audio input from surroundings

12. Security audio access

### DESCRIPTION OF THE PREFERRED EMBODIMENTS

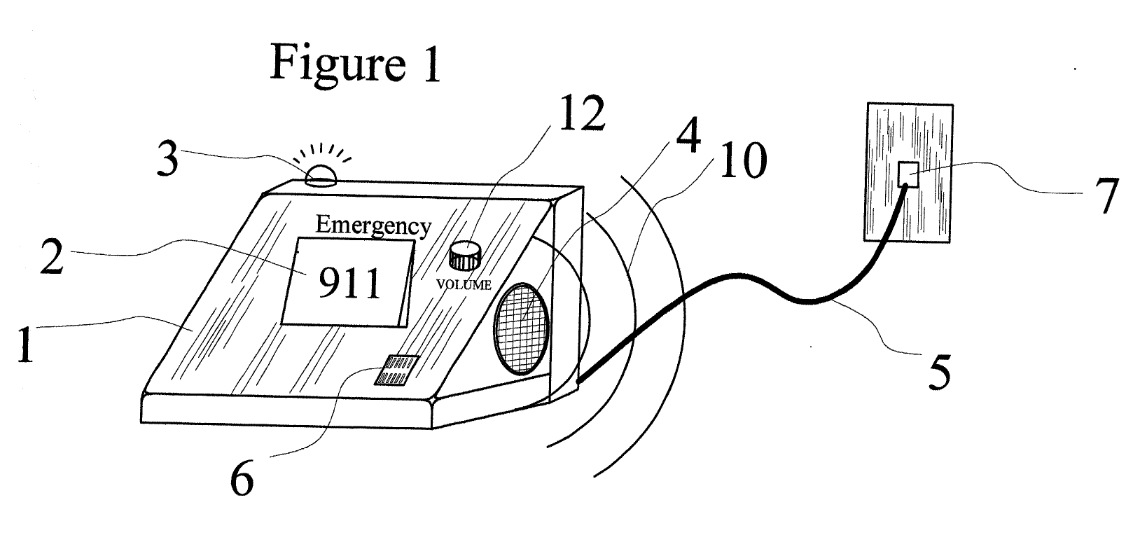

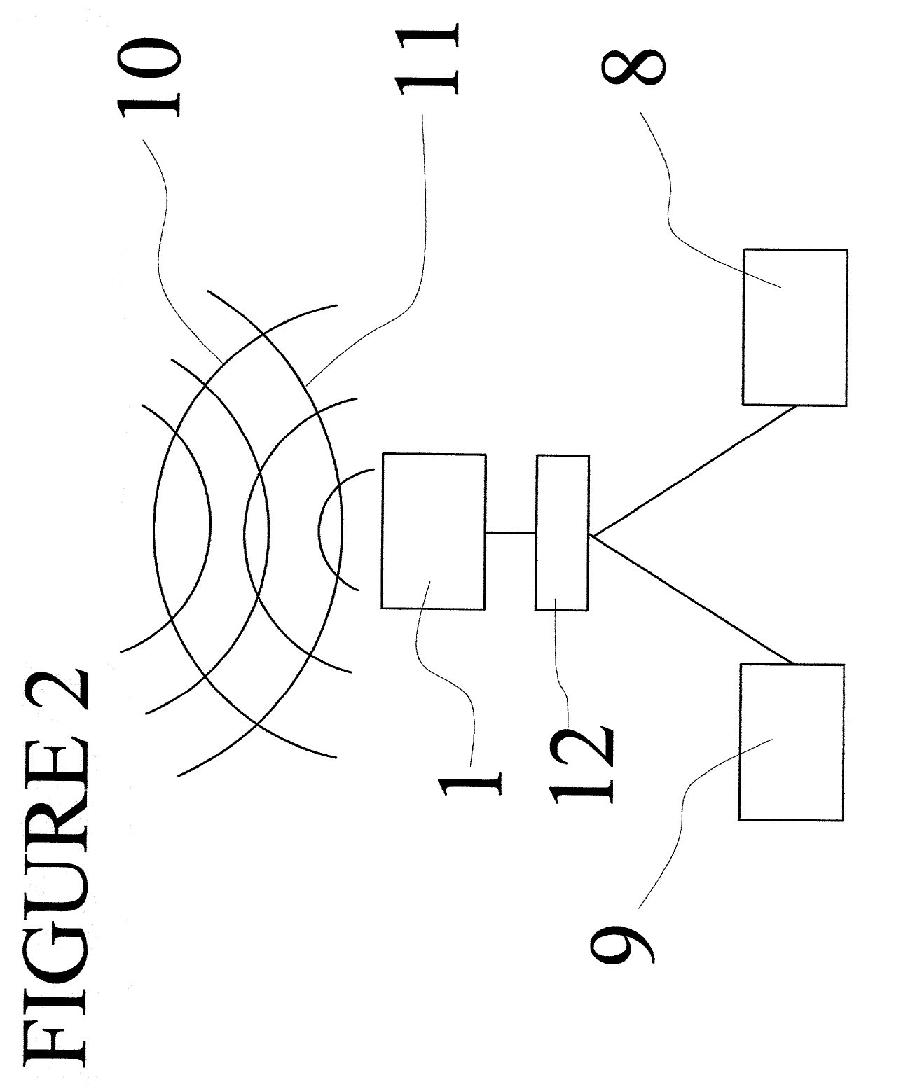

Referring now to FIGS. 1 and 2 we see the apparatus 1 having a single button 2 for dialing an emergency operator. FIG. 1 show the apparatus 1 having a volume adjustment dial for allowing the volume to be adjusted by while the speakerphone is in use. A front microphone 6 is also located on the front of the apparatus 1 to allow maximum audio input from the surrounding area that is in close proximity. At the top of the device, we see a visual indicator 3 that notifies the user that the device is on and should be either turned off or acknowledge by the user. To the side or sides of the device, we see at least one speaker 4 giving out audio sounds 10 to the surrounding area. In addition, we see a phone line 5 connecting the apparatus 1 to a phone wall jack 7.

To use the apparatus 1, a user in need of emergency help simply presses the button 2 and he or she will hear a dial tone followed by the ringing of a 911 operator over the speakerphone. The person in need then tells the emergency operator his or her problem. Note, once the button 2 is pushed, the visual indicator 3 will be on and will stay on until the emergency call has ended. To turn the light off 3, the person simply presses the emergency button 2 again, and the device is turned off.

For remote activation, the voice recognition software provided is continually activated. A person in need of emergency simply says “Help 911” and the microphone of the apparatus 1 will compare voice signatures with the apparatus's internal database. If a match occurs, a call will be placed to a 911 operator and the person in need can communicate with the operator via the speakerphone.

FIG. 2 shows a block flow diagram that enables an emergency operator or legal guardian to command the apparatus 1 to activate and engage in speakerphone capabilities. If for example, a person is physically incapacitated and cannot reach the phone, an emergency operator simply sends a command signal to the apparatus 1 to engage and allow two-way communication between the person in need of help and the 911 operators. If a legal guardian needs to get through to the apparatus 1 during emergencies, the legal guardian simply calls the emergency apparatus 1 via the telephone line 5 and enters a secret pin number that the emergency device recognizes as being valid and two-way communication is established so that the legal guardian can speak over the speakerphone to either listen to the incoming audio from the apparatus 1, speak over the speaker 4 to get the attention of anyone within hearing distance of the apparatus 1 or both.

A smoke detector can also be integrated into the emergency device such that if there were a fire in close proximity, the apparatus 1 would detect smoke and automatically dial an emergency operator such that the emergency operator could then communicate with anyone inside or just listen over the microphone 6 to see if there is anyone inside that needs help.

Since minor changes and modifications varied to fit particular operating requirements and environments will be understood by those skilled in the art, the invention is not considered limited to the specific examples chosen for purposes of illustration, and includes all changes and modifications which do not constitute a departure from the true spirit and scope of this invention as claimed in the following claims and reasonable equivalents to the claimed elements.

What is claimed is:

1. An emergency telephonic apparatus for calling an emergency operator, said apparatus comprising:
a. An emergency button affixed to said apparatus to notify an emergency operator of an emergency,
b. A speaker affixed to said apparatus for allowing hands free operation of said apparatus,
c. A microphone affixed to said apparatus for allowing audio input into said apparatus,
d. Voice recognition software electrically integrated into said apparatus thereby allowing a person to call an emergency operator,
e. A visual indicator affixed to said apparatus giving the status of the said apparatus,
f. A volume adjustment means affixed to said apparatus allowing the volume of said apparatus to be adjusted,
g. Security software means electrically integrated into said apparatus thereby allowing access to said apparatus by only authorized personnel from a remote location.
